(19) United States
(12) Patent Application Publication
(10) Pub. No.: US 2016/0357863 A1
(43) Pub. Date: Dec. 8, 2016

(54) AUTOMATIC PLAYLIST GENERATION FOR A CONTENT COLLECTION

(71) Applicant: Microsoft Technology Licensing, LLC, Redmond, WA (US)

(72) Inventors: Arnaud Albalat, Marseillan (FR); Guillaume Convers, Paris (FR); Fathallah Labhalla, Montigny-Le-Bretonneux (FR); Sebastien Lecomte, Montigny-Le-Bretonneux (FR); Manuel Millot, Saint-Germain-en-Laye (FR); Herve Ndoguefouba, Cergy (FR); Paul Nogues, Vanves (FR); Buu-Minh Ta, Paris (FR)

(21) Appl. No.: 14/732,453

(22) Filed: Jun. 5, 2015

(51) Int. Cl. G06F 17/30

(52) U.S. Cl. CPC G06F 17/30772; G06F 17/3053; G06F 17/30752

(57) ABSTRACT

Examples are disclosed that relate to the automatic creation of playlists. For example, one disclosed example provides, on a computing device comprising a processor, a method for generating playlists of content items from a collection of content items. The method comprises determining a set of candidate playlists, where each candidate playlist may include a different plurality of content items selected from the collection of content items. The method further comprises assigning a score to each candidate playlist in the set, and presenting via a display a subset of candidate playlists. Each candidate playlist in the subset may be selected from the set of candidate playlists based on the assigned score of the candidate playlist.

### BACKGROUND

A playlist may be used to organize a plurality of content items, such as music tracks, into an ordered list for presentation to a user. A playlist of songs, for example, may be played to evoke a desired atmosphere by presenting multiple songs with common characteristics that contribute to the atmosphere.

### SUMMARY

Examples are disclosed that relate to the automatic creation of playlists. For example, one disclosed example provides, on a computing device comprising a processor, a method for generating playlists of content items from a collection of content items. The method comprises determining a set of candidate playlists, where each candidate playlist may include a different plurality of content items selected from the collection of content items. The method further comprises assigning a score to each candidate playlist in the set, and presenting via a display a subset of candidate playlists. Each candidate playlist in the subset may be selected from the set of candidate playlists based on the assigned score of the candidate playlist.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example computing environment.

FIG. 2 shows an example content item including a plurality of attributes.

FIG. 3 shows a schematic depiction of a process for determining candidate playlists.

FIG. 4 shows an example hierarchy of attribute values for an attribute.

FIG. 5 shows an example method for generating playlists of content items from a collection of content items.

FIG. 6 shows an example method for applying content item selection rules.

FIGS. 7-10 show example methods for applying exclusion rules to candidate playlists.

FIG. 11 shows an example computing system.

### DETAILED DESCRIPTION

Some approaches for generating playlists of content items include selecting content items from among a content provider's whole catalog of content. However, a user may not have access to some content items in a playlist due to access restrictions placed on the content items.

Accordingly, examples are disclosed that relate to automatically generating playlists of content items using content items selected from a user's collection of content items, rather than a content provider's entire catalog. Because such playlists contain only content items from the user's collection, the playlists can be played by that user without access restrictions.

As described in more detail below, the disclosed examples automatically generate playlists of content items from a collection of content items by clustering content items according to different combinations of shared attribute values. For example, to provide a diverse selection of playlists, a playlist generation approach may include determining a set of candidate playlists that includes candidate playlists associated with every combination of attribute values for the attributes of the content items in the collection. Further, so as not to overwhelm the user with a substantial number of playlists, a playlist generation approach may include intelligently selecting a subset of candidate playlists from the set according to a scoring system that is applied to each candidate playlist, e.g. by applying various selection/exclusion rules to the candidate playlists to reduce a number of candidate playlists that are eligible for inclusion in the subset of playlists. Once the subset of candidate playlist is generated, the subset may be presented to the user to allow the user to explore the collection of content items in new and diverse ways that do not require manual interaction or maintenance by the user.

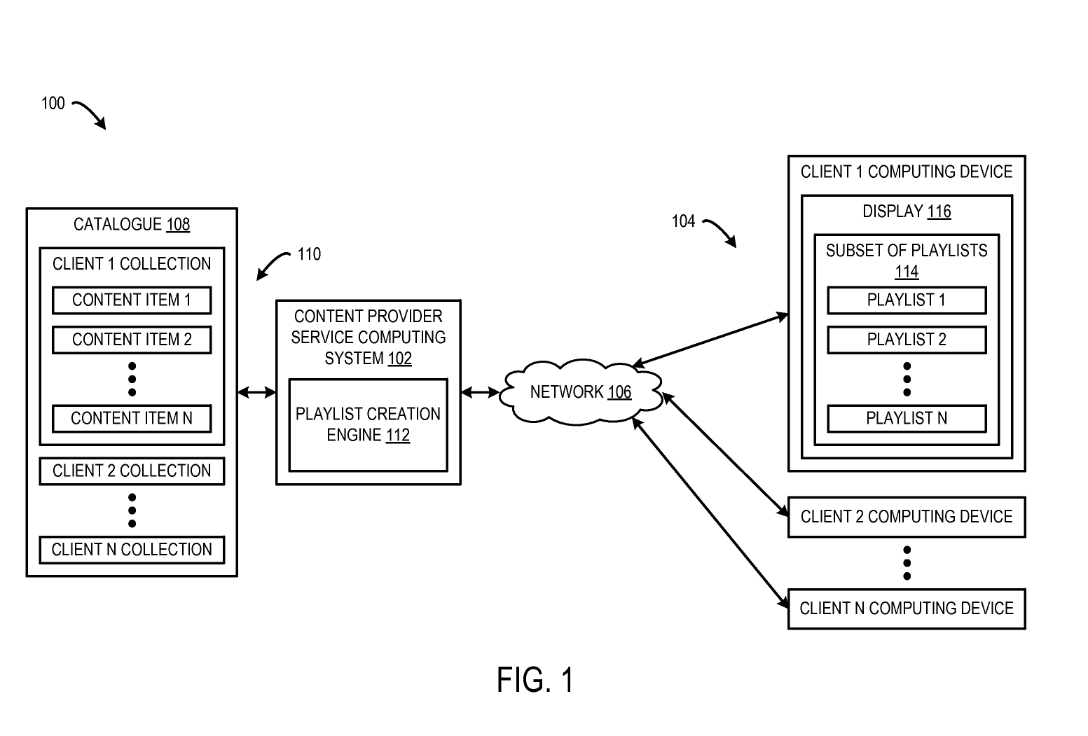

Prior to discussing these examples in more detail, an example computing environment 100 is described with reference to FIG. 1. The computing environment 100 includes a content provider service computing system 102 in communication with a plurality of client computing devices 104 via a network 106, such as the Internet. The content provider service computing system 102 may be configured to selectively provide the plurality of client computing devices 104 access to various content items in a catalogue 108. The content items in the catalogue 108 may include any suitable type of content items. Non-limiting examples of content items include music tracks, spoken-word audio tracks, podcasts, music videos, movies, television programs, images, and digital photographs.

The content provider service computing system 102 may be configured to provide users of the client computing devices 104 with a marketplace (or other interface) that allows a user to obtain, via a client computing device, various access rights to different content items in the catalogue 108. For example, the content provider service computing system 102 may be configured to provide a user with a subscription to access some or all content items in the catalogue 108, via a client computing device associated with the user. In another example, the content provider service computing system 102 may be configured to provide a permanent access license for a selected content item (e.g., a purchased content item) to a user. In some implementations, such subscription and permanent access rights may allow a user to temporarily download and store a content item locally on a client computing device. Likewise, in some implementations, such subscription and permanent access rights may allow a client computing device to permanently download and store a content item locally on the client computing device.

Each user may have a different set of access rights that allows access to a different collection of content items in the catalogue 108. Thus, a plurality of collections 110 corresponding to the different users of the computing environment 100 may be stored and managed by the content provider service computing system 102. Further, in some implementations, each client computing device can manage a collection of content items of a user locally on the client computing device.

The content provider service computing system 102 may include a playlist creation engine 112 configured to determine, for each user, a different set of candidate playlists. Each candidate playlist in a set may include a different selection of content items from the collection of that user. The playlist creation engine 112 further may be configured to assign a score to each candidate playlist in the set, and to present a subset 114 of candidate playlists via a display 116 or other suitable interface of a client computing device associated with the user based on the assigned score of the candidate playlist.

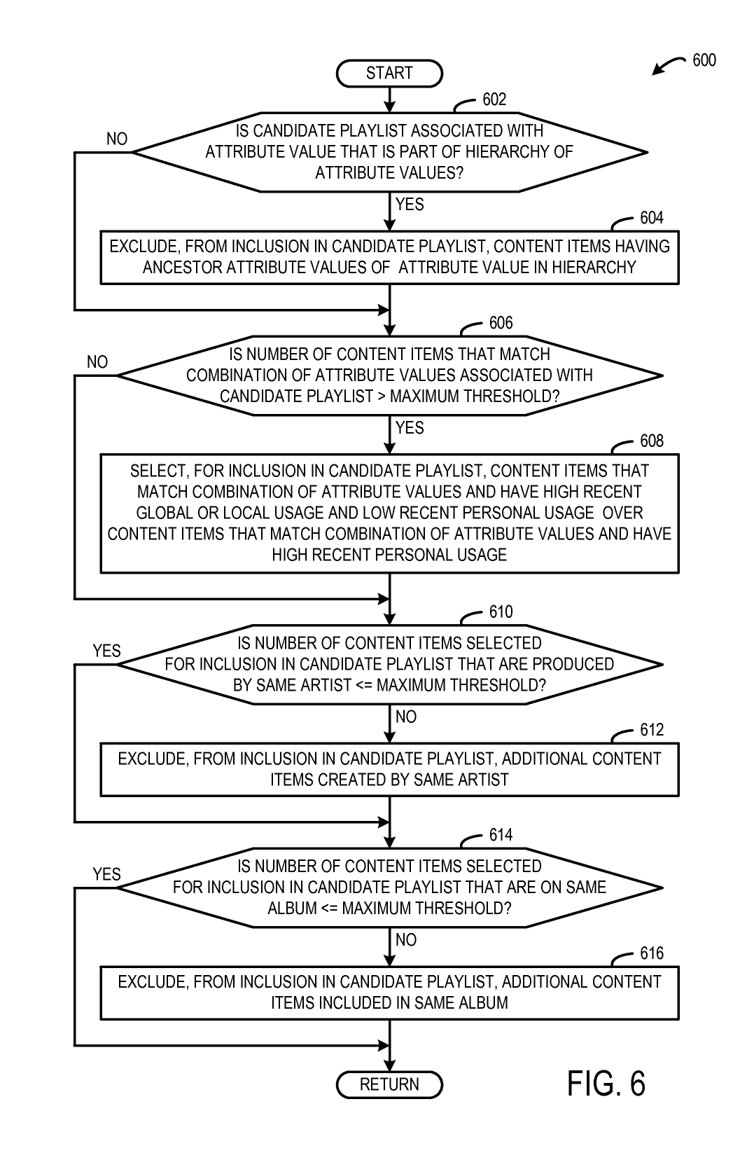

In some implementations, all candidate playlists in the set may be assigned a score. In other implementations, one or more exclusion rules may be applied to the candidate playlists in the set before scores are assigned to remaining candidate playlists. Scores may be assigned to the candidate playlists in any suitable manner. Example methods of assigning scores are described in further detail below with reference to FIG. 5.

In some examples, each time the playlist creation engine 112 generates the subset 114 of playlists for a selected user, the playlist creation engine 112 may select different playlists for inclusion in the subset 114 based on various changing characteristics of the playlists. For example, the playlist creation engine 112 may select a playlist for inclusion in the subset 114 based on usage of content items included in the playlist, such that changes in usage of a content item may change the likelihood of the playlist being included in the subset presented to the user. It will be understood that any suitable characteristic of a playlist and/or content items included in a playlist may be used to select a playlist for inclusion in the subset 114.

Moreover, each time the playlist creation engine 112 generates a playlist for inclusion in the subset 114, the playlist creation engine 112 may select different content items for inclusion in that playlist based on various changing characteristics of the content items. For example, the playlist creation engine 112 may select content items for inclusion in a playlist based on usage, such that changes in usage of a content item may change the likelihood of the content item being included in the playlist.

Although the playlist creation engine 112 is depicted in the computing environment 100 as being located at the content provider service computing system 102, in some implementations, the playlist creation engine 112 may be optionally or alternatively located on client computing devices for local operation by the client computing devices. When located on a client computing device, in some cases, the playlist creation engine 112 may determine the subset 114 of playlists for a collection locally stored on the client computing device without involvement of the content provider service computing system 102.

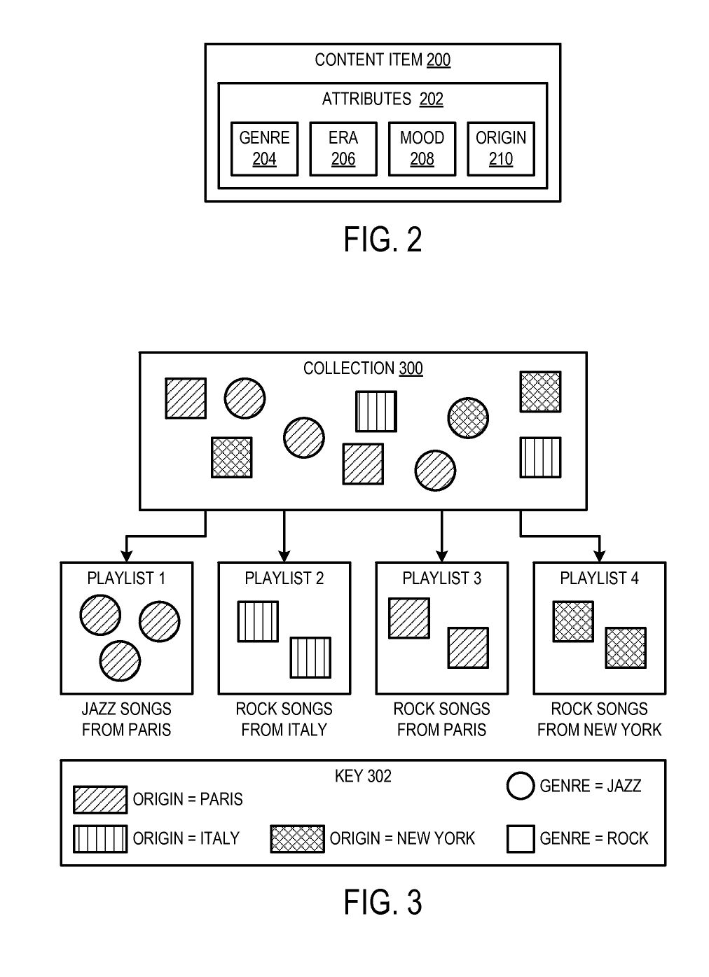

The playlist creation engine 112 may be configured to determine each candidate playlist in the set of candidate playlists by clustering content items in the collection according to attribute values of the content items. FIG. 2 schematically shows an example content item 200, and illustrates a plurality of attributes 202, which may take the form of metadata in a data structure that represents the content item in the catalogue 108. In the depicted implementation, the attributes are shown as genre 204, era 206, mood 208, and geographic origin 210, but it will be understood that any suitable attributes may be used. The playlist creation engine 112 may be configured to determine candidate playlists associated with different combinations of attribute values for the genre attribute 204, the era attribute 206, the mood attribute 208, and the geographical origin attribute 210 of the content items in the collection. In one example, the playlist creation engine 112 may be configured to determine candidate playlists corresponding to all combinations of attribute values for content items in the collection.

In some implementations, each content item in the catalogue 108 and/or a collection of content items may have a standard set of attributes. In other implementations, different content items in the catalogue 108 and/or a collection of content items may have different sets of attributes that are not standardized.

In some cases, a content item may include more than one attribute value for an attribute. For example, a content item may have a Fun attribute value and an Energetic attribute value for the mood attribute. As such, a content item may be included in more than one candidate playlist of the set of candidate playlists based on the attribute values of the content item being applicable to multiple candidate playlists.

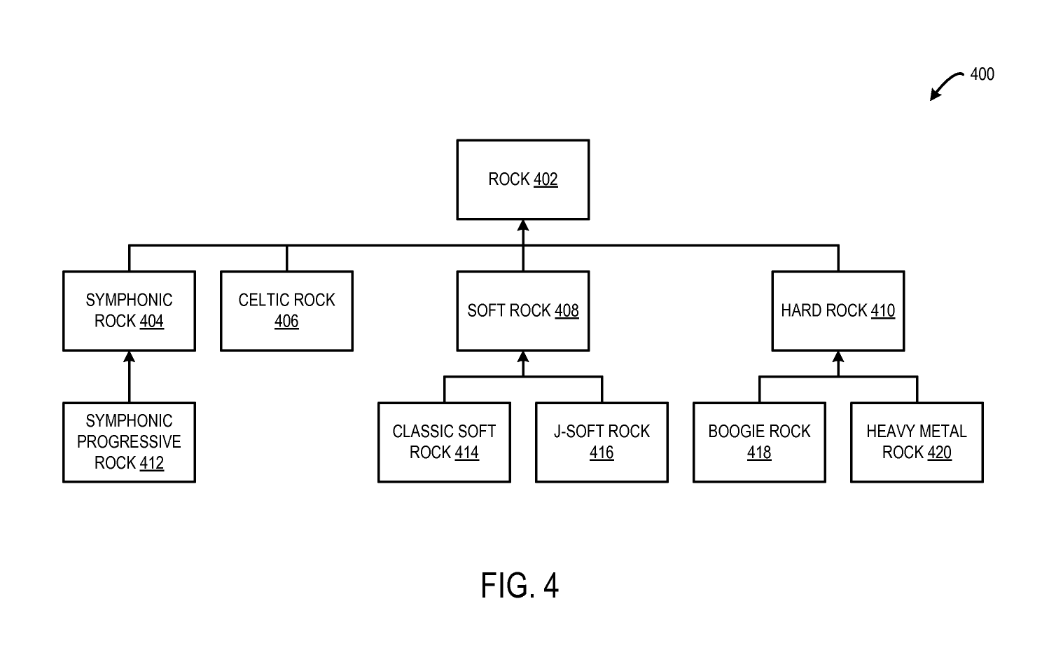

FIG. 3 shows a schematic depiction of a process for determining candidate playlists from a collection 300 of content items based on different combinations of attribute values of the content items in the collection. The content items may represent songs, and the shapes and fill patterns represent attribute values indicated in the key 302.

The playlist creation engine 112 may be configured to use attribute values for each of the songs in the collection 300 in order to cluster the songs into different playlists. In the depicted example, a content item that is represented by a circle has a genre attribute value of Jazz. A content item that is represented by a square has a genre attribute value of Rock. A content item that is represented by a diagonal pattern has a geographical origin attribute value of Paris. A content item that is represented by a vertical pattern has a geographical origin attribute value of Italy. A content item that is represented by a crosshatch pattern has a geographical origin attribute value of New York.

The attribute values of the content items in the collection 300 may be grouped into different combinations, and each combination may be used to populate a different playlist. In the depicted example, a first playlist includes Jazz songs from Paris. In this playlist, each song has a genre attribute value corresponding to Jazz and a geographical origin attribute value corresponding to Paris. The second playlist includes Rock songs from Italy. In this playlist, each song has a genre attribute value corresponding to Rock and a geographical origin attribute value corresponding to Italy. The third playlist includes Rock songs from Paris. In this playlist, each song has a genre attribute value corresponding to Rock and a geographical origin attribute value corresponding to Paris. The fourth playlist includes Rock songs from Italy. In this playlist, each song has a genre attribute value corresponding to Rock and a geographical origin value corresponding to Italy. Note that combinations of attributes other than the depicted combinations are possible, including combinations based upon a single attribute or three or more different attributes (though only two are shown).

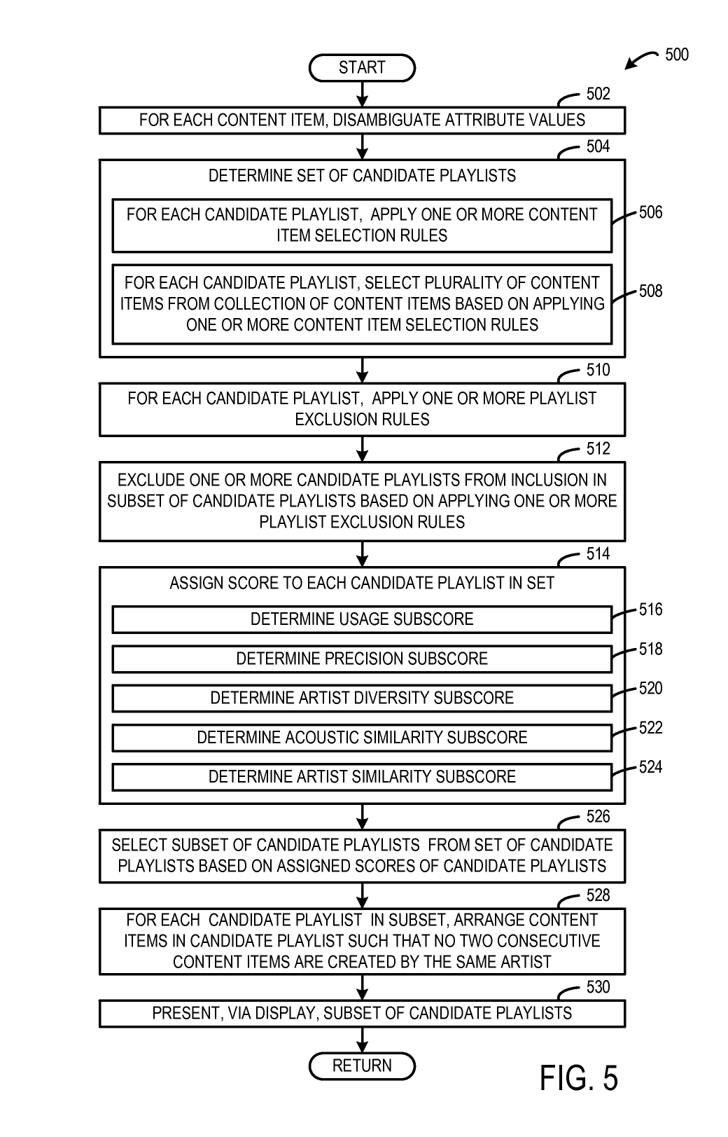

Some attributes may have a defined hierarchy of attribute values that may affect how the playlist creation engine 112 selects content items for inclusion in a playlist. FIG. 4 shows an example hierarchy 400 of a genre attribute. In this example, the broadest attribute value in the hierarchy is a Rock attribute value 402. The Rock attribute value 402 is depicted as having a Symphonic Rock attribute value 404, a Celtic Rock attribute value 406, a Soft Rock attribute value 408, and a Hard Rock attribute value 410 as child values. The Rock attribute value 402 is also classified as a parent of these attribute values.

An attribute value hierarchy may have any suitable number of levels. For example, the Symphonic Rock attribute value 404 is depicted as having a Symphonic Progressive Rock attribute value 412 as a child value. The Soft Rock attribute value 408 has Soft Classic Rock attribute value 414 and a J-Soft Rock attribute value 416 as child values. The Hard Rock attribute value 410 is depicted as having a Boogie Rock attribute value 418 and a Heavy Metal Rock attribute value 420 as child values. Note that the hierarchy 400 is merely one example of a hierarchy structure, and any suitable hierarchy structure may be employed to classify attribute values without departing from the scope of the present disclosure.

In the hierarchy 400, any attribute value that is in a level below a level of a given attribute value may be classified as a descendent of the given attribute value. Likewise, in the hierarchy 400, any attribute value that is in a level above a level of a given attribute value may be classified as an ancestor of the given attribute value. Ancestor/descendant relationships may be used by the playlist creation engine 112 when selecting content items for inclusion in a playlist, as well as when excluding candidate playlists from the subset.

FIG. 5 shows an example method 500 for generating playlists of content items from a collection of content items. It will be understood that method 500 may be performed by a computing device including a processor, such as the content provider service computing system 102 and/or any of the plurality of client computing devices 104 shown in FIG. 1.

At 502, the method 500 may include, for each content item in a collection of content items, disambiguating attribute values of the content item. For example, a content item may have two or more attribute values for a given attribute. In this instance, the less accurate attribute value(s) may be removed or ignored when considering the content item for inclusion in a playlist. As one example, a song may have both 70's and 2000's listed as era attribute values. As the 2000's attribute value may represent a re-release of the song, such as part of a greatest hits album, the 2000's attribute value may be ignored or removed from consideration. In another example, an overly vague or meaningless attribute value may be ignored or removed from consideration. For example, the era attribute value “20^{th} Century” may be determined to be overly broad, and may be removed from consideration.

At 504, method 500 may include determining a set of candidate playlists. The set of candidate playlists may include candidate playlists associated with different combinations of attribute values, wherein each content item in a given candidate playlist has a same combination of attribute values. In some implementations, the set of candidate playlists may include candidate playlists associated with every combination of attribute values for the attributes of the content items in the collection. In such an implementation, using the attributes of FIG. 2 as an example, candidate playlists may be determined for every attribute value combination of the genre, era, mood, and geographical origin attributes, including playlists for single attribute values.

In some implementations, determining the set of candidate playlists may include, at 506, for each candidate playlist, applying one or more content item selection rules, and at 508, selecting a plurality of content items from the collection of content items for inclusion in each candidate playlist based on the one or more content item selection rules.

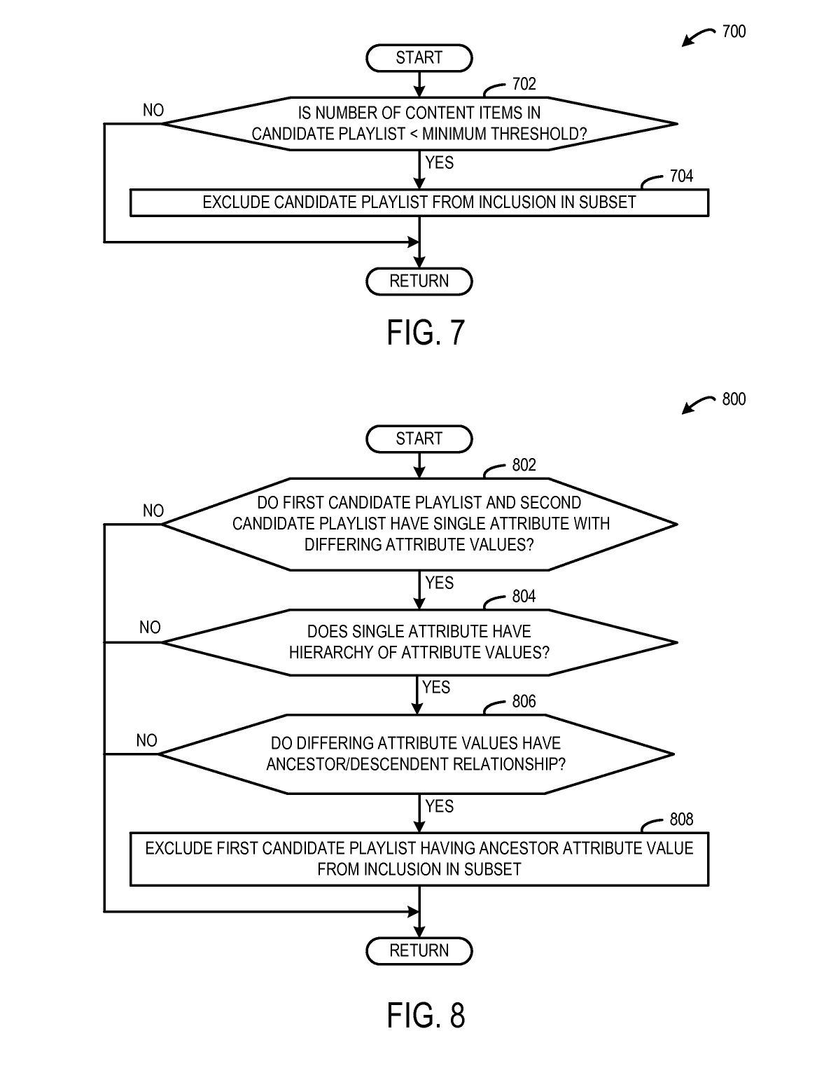

The content item selection rules may determine which content items are selected for inclusion in a given playlist. FIG. 6 shows an example method 600 for applying content item selection rules to help select which content items to include in a candidate playlist. It will be understood that method 600 may be performed by a computing device including a processor, such as the content provider service computing system 102 or any of the plurality of client computing devices 104 of FIG. 1. Further, it will be understood that the selection rules presented in FIG. 6 are presented for the purpose of example, and that any suitable set of selection rules may be used.

At 602, method 600 may include, for a given attribute value associated with the candidate playlist, determining whether the value is part of a hierarchy of attribute values. If the attribute values is determined to be included in a hierarchy of attribute values, then the method 600 moves to 604. Otherwise, the method 600 moves to 606.

At 604, method 600 may include excluding content items having ancestor attribute values of the attribute value in the hierarchy from inclusion in the candidate playlist. For example, returning to the hierarchy 400 of FIG. 4, if the attribute value corresponding to the candidate playlist is Soft Rock 408, then songs labeled with the attribute value Rock 402 may be excluded from the candidate playlist. Process 604 also may include designating content items having an attribute value that is a descendent of the attribute value associated with the candidate playlist eligible for inclusion in the candidate playlist. For example, returning to the hierarchy 400 of FIG. 4, if the attribute value corresponding to the candidate playlist is Soft Rock 408, then songs having the attribute value Classic Soft Rock 414 or the attribute value J-Soft Rock 416 may be made eligible for inclusion in the candidate playlist.

At 606, method 600 may include determining whether a number of content items that match the combination of attribute values of the candidate playlist (or are otherwise eligible for inclusion in the candidate playlist) is greater than a maximum threshold number of content items. As one non-limiting example, the maximum number of content items in a candidate playlist may be set at 50 content items. In other examples, the maximum threshold number may be set to any other suitable number of content items. If the number of content items is greater than the maximum threshold number of content items, then the method 600 moves to 608. Otherwise, the method 600 moves to 610.

At 608, the method 600 may include selecting content items that match the combination of attribute values and have a high recent global or local geographic usage and a low recent personal usage for inclusion in the candidate playlist over content items that match the combination of attribute values and have a high recent personal usage.

Recent usage may be defined as a number of times a content item has been consumed within a selected duration (e.g., within the last day, week, month, or another duration). Local geographic usage may be defined by a region (e.g., a city, a state, a country, or another region) proximate to a location of the client computing device at which the candidate playlist may be presented. Global geographic usage may be defined by a number of times a content item has been consumed by a total population of users of the catalogue 108, the content provider service computing system 102 of FIG. 1, or another community of users. Personal usage may be defined as a number of times a content item has been consumed by a user/client computing device. By selecting content items that have a high local geographic or global geographic usage and a low personal usage, generally popular content items may be presented to the user that may be considered by the user as fresh or new.

At 610, method 600 may include determining whether a number of content items selected for inclusion in the candidate playlist that are produced by a selected artist is less than or equal to a maximum threshold number. In one non-limiting example, the maximum threshold number may be set to 7 content items. In other examples, the maximum threshold number may be set to any other suitable number. If the number of content items included in the playlist is less than or equal to the maximum threshold number, then the method 600 moves to 614. Otherwise, the method 600 moves to 612, where method 600 includes excluding, from inclusion in the candidate playlist, additional content items by the selected artist. By limiting a number of content items included in the candidate playlist that are created by a given artist, the candidate playlist may include a diverse selection of content items.

At 614, method 600 may include determining whether a number of content items selected for inclusion in the candidate playlist that are from a same album is less than or equal to a maximum threshold number of content items. In one example, the maximum threshold number is set to 4 content items. In other examples, the maximum threshold number may be set to any other suitable number. If the number of content items included in the playlist is less than or equal to the maximum threshold number, then the method 600 returns to other operations. Otherwise, the method 600 moves to 616. At 616, method 600 may include excluding, from inclusion in the candidate playlist, additional content items from the same album. By limiting a number of content items included in the candidate playlist that are from the same album, the candidate playlist may include a diverse selection of content items.

Returning to FIG. 5, at 510, method 500 may include, for each candidate playlist, applying one or more playlist exclusion rules. The playlist exclusion rules may determine which candidate playlists are excluded from being eligible for inclusion in the subset of candidate playlists that is presented to the user.

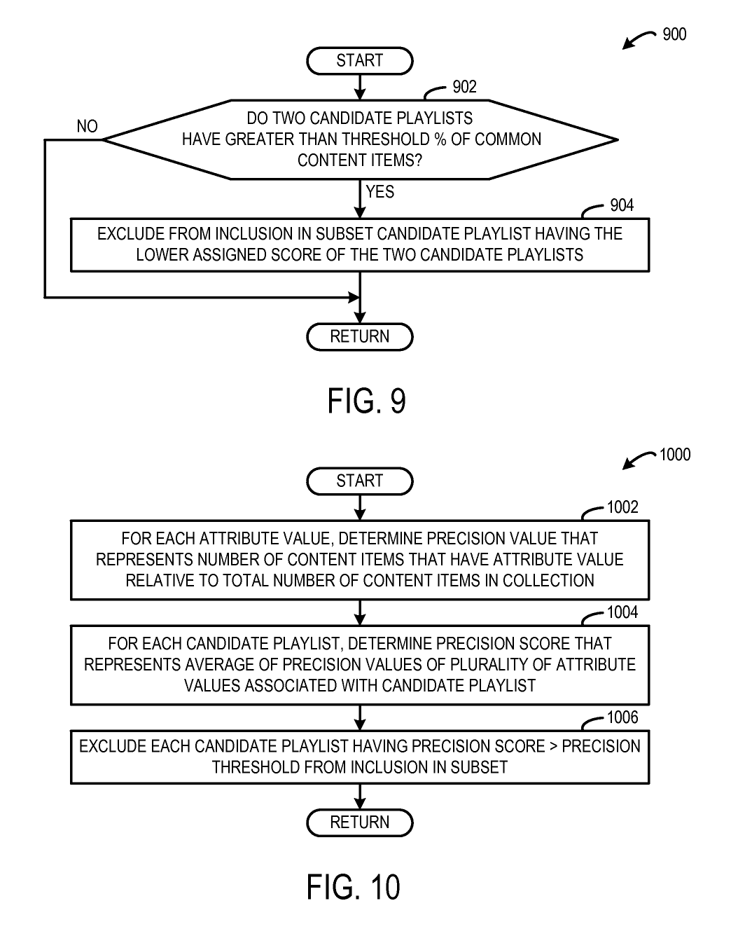

FIGS. 7-10 show example methods for applying different example playlist exclusion rules to exclude candidate playlists from inclusion in the subset of candidate playlists. It will be understood that the methods of FIGS. 7-10 may be performed by a computing device including a processor, such as the content provider service computing system 102 and/or any of the plurality of client computing devices 104 shown in FIG. 1.

FIG. 7 shows a first example candidate playlist candidate exclusion method 700. At 702, method 700 includes determining whether a number of content items in the candidate playlist is less than a minimum threshold number of content items. In one example, the minimum threshold number is set to 15. In other examples, the minimum threshold number may be set to any other suitable number. If the candidate playlist includes a number of content items that is less than the minimum threshold number, then the method 700 includes, at 704, excluding the candidate playlist from inclusion in the subset of candidate playlists. Otherwise, the candidate playlist is not excluded.

As the candidate playlists are formed content items in a user's collection, there may be particular attribute values that are not well represented by the content items in the collection. As such, some candidate playlists may not have a sufficient number of content items to be useful or interesting, and such candidate playlists may be excluded from the subset. Accordingly, FIG. 8 another example candidate playlist candidate exclusion method 800. At 802, method 800 may include determining whether a first candidate playlist and a second candidate playlist have only a single attribute with differing attribute values. If the first and second candidate playlists have more than a single attribute with differing values, then the candidate playlist is not excluded.

On the other hand, if the first and second candidate playlists have only a single attribute with differing attribute values, then the method 800 includes determining whether the single attribute having the differing attribute values has a hierarchy of attribute values. If not, then the candidate playlist is not excluded. On the other hand, if the single attribute has a hierarchy of attribute values, then the method 800 determines, at 806, whether the differing attribute values of the single attribute have an ancestor/descendent relationship (e.g. a parent/child relationship) in the hierarchy of attribute values. If the differing attribute values have an ancestor/descendent relationship, then the method 800 includes, at 808, excluding the first candidate playlist from the subset of playlists. Otherwise, the first candidate playlist is not excluded.

As an illustrative example, returning to the hierarchy 400 of FIG. 4, the first candidate playlist may be characterized by Energetic, Rock songs of the 90's from Europe, and the second candidate playlist may be characterized by Energetic, Boogie Rock songs of the 90's from Europe. As the Boogie Rock attribute value provides a more precise representation of the group, the second candidate playlist may be considered for inclusion in the subset over the first candidate playlist. This particular exclusion rule may be applied to prevent repetition among candidate playlist included in the subset.

FIG. 9 shows another example playlist candidate exclusion method 900. At 902, method 900 may include determining whether two candidate playlists have greater than a threshold percentage of common content items. In one example, the threshold percentage is set to 50%. In other examples, the threshold percentage may be set to any other suitable percentage. If the two candidate playlists do not have greater than the threshold percentage of common content items, then neither candidate playlist is excluded. Otherwise, method 900 includes, at 904, excluding from the subset a candidate playlist of the two candidate playlists having a lower assigned score.

In some implementations, a candidate playlist having more than a threshold percentage of common artists with another candidate playlist may be excluded from inclusion in the subset. In such implementations, a higher scoring candidate playlist may included in the subset over a lower scoring candidate playlist. The commonality of artist may be determined, for example, by the following relationship.

(Number of Artists in both candidates)/(Number of Artists in at least one of the 2 candidates)>0.5

FIG. 10 shows a playlist candidate exclusion method that excludes based upon commonality of artist. At 1002, method 1000 includes, for each attribute value, determining a precision value that represents a number of content items that have the attribute value relative to a total number of content items in the collection. In one example, a precision value of a geographical origin attribute value of “Amsterdam” may be 0.16% where 0.16% of the content items in the collection have the attribute value “Amsterdam.”

At 1004, method 1000 includes, for each candidate playlist, determining a precision score that represents an average of the precision values of the plurality of attribute values that are associated with the candidate playlist. At 1006, method 1000 includes excluding each candidate playlist having a precision score that is greater than a threshold percentage. In one example, the threshold percentage may be set to 50%. In other examples, the threshold percentage may be set to any other suitable percentage. Such an exclusion rule may be applied to filter out playlists that may be considered to be overly broad.

It will be understood that any above described exclusion rules may be applied, alone or in combination, to exclude candidate playlists from the subset. Further, any suitable exclusion rules other than those of FIGS. 7-10 may be applied to candidate playlists in the set.

Returning to FIG. 5, method 500 may include, at 510, excluding one or more candidate playlist from inclusion in the subset of candidate playlist based on applying the one or more playlist exclusion rules. By excluding candidate playlists that are overly broad or repetitive, a number of eligible candidate playlists that have to be assigned a score may be reduced relative to an approach that scores all candidate playlists in the set.

At 514, method 500 may include assigning a score to each candidate playlist in the set. In some implementations, scoring may be performed after applying exclusions. In other implementations, scoring may be performed before the application of at least some exclusions.

Any suitable scoring metric may be employed to assign a score to each candidate playlist. In one example, a playlist score may be based on various subscores including a usage subscore, a precision subscore, an artist diversity subscore, an acoustic similarity subscore, and an artist similarity subscore. In this example, as indicated at 516, method 500 may include determining the usage subscore of each candidate playlist in the set. The usage subscore may reflect how much a user has consumed the content items in the candidate playlist. The usage subscore may be determined, for example, by:

UsageSubScore=1+log(1+Average Usage in Playlist/(1+Average Usage of User)),

where “usage” is the number of times a content item has been consumed by the user.

At 518, method 500 may include determining the precision subscore of each candidate playlist in the set. The precision subscore may reflect how precisely the combination of attribute values that define the candidate playlist represent content items in the collection. In one example, the precision subscore may be determined by:

Precision=MoodWeight*MoodAccuracy+GenreWeight*GenreAccuracy+EraWeight*EraAccuracy+OriginWeight*OriginAccuracy,

where MoodAccuracy=1.0 if there is no mood in the definition of the playlist, and 1.2 if there is one. GenreAccuracy, EraAccuracy and OriginAccuracy represent a percentage of content items in the collection that are annotated with the specific attribute values genre, era, or origin.

At 520, method 500 may include determining the artist diversity subscore of each candidate playlist in the set. The artist diversity subscore may be based, for example, on an entropy of a probability distribution defined by artist counts in the candidate playlist and thus may reflect how much there are different artists in the playlist. In one example, the artist diversity subscore may be determined by:

Artist diversity=(−Σₖ₌₁ⁿpₖ log pₖ)

where n is the number of artists in the playlist, and p_k is the proportion of content items in the playlist from the artist k.

At 522, method 500 may include determining the acoustic similarity subscore of each candidate playlist in the set. In one example, the acoustic similarity subscore may be determined as a mean acoustic distance between two content items in the candidate playlist. The acoustic distance may be given by any suitable acoustic distance model.

Likewise, at 524, the method 500 may include determining the artist similarity subscore of each candidate playlist in the set. In one example, the precision subscore may be determined by as a mean artist-to-artist similarity between two artists of content items in the candidate playlist. The artist similarity subscore may be determined by any suitable artist similarity model.

The subscores may be combined in any suitable manner to provide the assigned score for a candidate playlist. In one example, the usage subscore, the acoustic similarity subscore, and the artist similarity subscore may be weighted less than the precision subscore and the artist diversity subscore. In other examples, any other suitable weightings may be used, or the scores may be weighted equally.

Continuing, method 500 includes, at 526, selecting a subset of candidate playlists from the set of candidate playlists based on the assigned scores of the candidate playlists. In one example, the top 20 candidate playlists having the highest assigned scores may be selected as the subset of candidate playlists. In other examples, any other suitable number of playlists may be selected for inclusion in the subset.

At 528, method 500 may include, for each candidate playlist in the subset, arranging the content items in the candidate playlist such that no two consecutive content items are created by the same artist. Accordingly, the content items created by the same artist may be more evenly distributed throughout the candidate playlist.

At 530, the method 500 may include presenting, via a display of the computing device, the subset of candidate playlists. Upon presenting the subset of candidate playlists, the method 500 may return to other operations.

In some embodiments, the methods and processes described herein may be tied to a computing system of one or more computing devices. In particular, such methods and processes may be implemented as a computer-application program or service, an application-programming interface (API), a library, and/or other computer-program product.

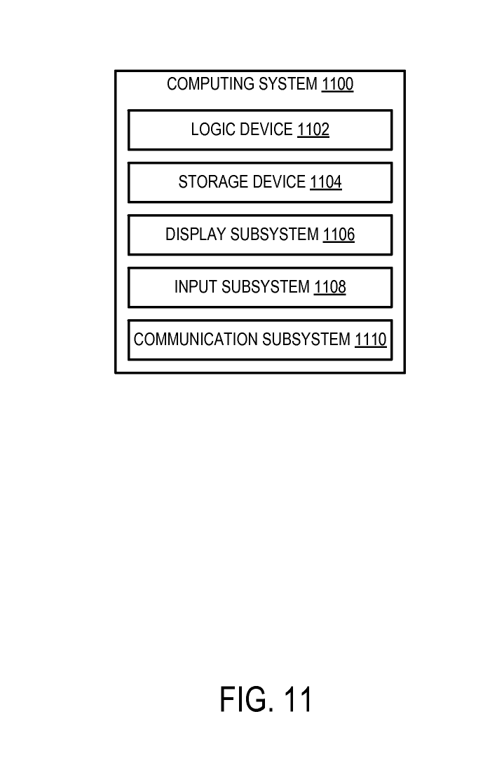

FIG. 11 schematically shows a non-limiting implementation of a computing system 1100 that can enact one or more of the methods and processes described above. Computing system 1100 is shown in simplified form. Computing system 1100 may take the form of one or more personal computers, server computers, tablet computers, home-entertainment computers, network computing devices, gaming devices, mobile computing devices, mobile communication devices (e.g., smart phone), and/or other computing devices. For example, computing system 1100 may represent the content provider service computing system 102, or any of the plurality of client computing devices 104 of FIG. 1.

Computing system 1100 includes a logic device 1102 and a storage device 1104. Computing system 1100 may optionally include a display subsystem 1106, input subsystem 1108, communication subsystem 1110, and/or other components not shown in FIG. 11.

Logic device 1102 includes one or more physical machines configured to execute instructions. For example, the logic device 1102 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic device 1102 may include one or more processors configured to execute software instructions. Additionally or alternatively, the logic device 1102 may include one or more hardware or firmware logic machines configured to execute hardware or firmware instructions. Processors of the logic device 1102 may be single-core or multi-core, and the instructions executed thereon may be configured for sequential, parallel, and/or distributed processing. Individual components of the logic device 1102 optionally may be distributed among two or more separate devices, which may be remotely located and/or configured for coordinated processing. Aspects of the logic device 1102 may be virtualized and executed by remotely accessible, networked computing devices configured in a cloud-computing configuration.

Storage device 1104 includes one or more physical machines configured to hold instructions executable by the logic device 1102 to implement the methods and processes described herein. When such methods and processes are implemented, the state of storage device 1104 may be transformed—e.g., to hold different data.

Storage device 1104 may include removable and/or built-in devices. Storage device 1104 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage device 1104 may include volatile, nonvolatile, dynamic, static, read/write, read-only, random-access, sequential-access, location-addressable, file-addressable, and/or content-addressable devices.

It will be appreciated that storage device 1104 includes one or more physical devices. However, aspects of the instructions described herein alternatively may be propagated by a communication medium (e.g., an electromagnetic signal, an optical signal, etc.) that is not held by a physical device for a finite duration.

Aspects of logic device 1102 and storage device 1104 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “engine” may be used to describe an aspect of computing system 1100 implemented to perform a particular function. In some cases, an engine may be instantiated via logic device 1102 executing instructions held by storage device 1104. It will be understood that different engines may be instantiated from the same application, service, code block, object, library, routine, API, function, etc. Likewise, the same engine may be instantiated by different applications, services, code blocks, objects, routines, APIs, functions, etc. The term “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1106 may be used to present a visual representation of data held by storage device 1104. This visual representation may take the form of a graphical user interface (GUI). As the herein described methods and processes change the data held by the storage device 1104, and thus transform the state of the storage device 1104, the state of display subsystem 1106 may likewise be transformed to visually represent changes in the underlying data. Display subsystem 1106 may include one or more display devices utilizing virtually any type of technology. Such display devices may be combined with logic device 1102 and/or storage device 1104 in a shared enclosure, or such display devices may be peripheral display devices.

When included, input subsystem 1108 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1110 may be configured to communicatively couple computing system 1100 with one or more other computing devices. Communication subsystem 1110 may include wired and/or wireless communication devices compatible with one or more different communication protocols. As non-limiting examples, the communication subsystem may be configured for communication via a wireless telephone network, or a wired or wireless local- or wide-area network. In some implementations, the communication subsystem may allow computing system 1100 to send and/or receive messages to and/or from other devices via a network such as the Internet.

Another example provides, on a computing device comprising a processor, a method for generating playlists of content items from a collection of content items. The method comprises determining, via the processor, a set of candidate playlists, each candidate playlist including a different plurality of content items selected from the collection of content items, assigning, via the processor, a score to each candidate playlist in the set, and presenting, via a display, a subset of candidate playlists. Each candidate playlist in the subset is selected from the set of candidate playlists based on the assigned score of the candidate playlist. In one example implementation that optionally may be combined with any of the features described herein, each content item in the collection of content items has a plurality of attributes, and each candidate playlist in the set is associated with a different combination of attribute values of the plurality of attributes such that each content item in a given candidate playlist has a same combination of attribute values. In one example implementation that optionally may be combined with any of the features described herein, the set of candidate playlists includes candidate playlists associated with every combination of attribute values for the attributes of the content items in the collection of content items. In one example implementation that optionally may be combined with any of the features described herein, the plurality of attributes include a genre, an era, a mood, and a geographical origin. In one example implementation that optionally may be combined with any of the features described herein, the method further comprises for each candidate playlist, selecting, via the processor, a plurality of content items from the collection of content items based on applying one or more content item selection rules. In one example implementation that optionally may be combined with any of the features described herein, one or more attributes of the plurality of attributes has a hierarchy of attribute values, and applying the one or more content item selection rules includes, if a candidate playlist is associated with an attribute value of an attribute that has a hierarchy of attribute values, then excluding content items having ancestor attribute values of the attribute value in the hierarchy from inclusion in the candidate playlist. In one example implementation that optionally may be combined with any of the features described herein, each candidate playlist includes a maximum threshold number of content items, and applying the one or more content item selection rules includes, if a number of content items that match the combination of attribute values associated with the candidate playlist is greater than the maximum threshold number of content items, then selecting content items that match the combination of attribute values and have a high recent local or global geographic usage and a low recent personal usage for inclusion in the candidate playlist over content items that match the combination of attribute values and have a high recent personal usage. In one example implementation that optionally may be combined with any of the features described herein, the method further comprises excluding, via the processor, one or more of the plurality of candidate playlists for inclusion in the subset of candidate playlist based on applying one or more playlist exclusion rules. In one example implementation that optionally may be combined with any of the features described herein, one or more attributes of the plurality of attributes includes a hierarchy of attribute values, and applying the one or more playlist exclusion rules includes, if a first candidate playlist and a second candidate playlist have a single attribute with differing attribute values, if the single attribute has a hierarchy of attribute values, and if the differing attribute values have an ancestor/descendent relationship, then excluding the first candidate playlist having the ancestor attribute value from inclusion in the subset of candidate playlists. In one example implementation that optionally may be combined with any of the features described herein, the method further comprises for each attribute value, determining a precision value that represents a number of content items that have the attribute value relative to a total number of content items in the collection, for each candidate playlist, determining a precision score that represents an average of the precision values of a plurality of attribute values associated with the candidate playlist, and applying the one or more playlist exclusion rules includes excluding each candidate playlist having a precision score greater than a precision threshold from inclusion in the subset of candidate playlists. In one example implementation that optionally may be combined with any of the features described herein, applying the one or more playlist exclusion rules includes, upon two candidate playlists having greater than a threshold percentage of common content items, excluding a candidate playlist of the two candidate playlists having a lower assigned score from inclusion in the subset of candidate playlists.

In another example implementation, a computing system comprises a logic device, a storage device holding instructions executable by the logic device to determine a set of candidate playlists, each candidate playlist including a different plurality of content items selected from a collection of content items, each content item in the collection of content items having a plurality of attributes, and each candidate playlist in the set being associated with a different combination of attribute values of the plurality of attributes such that each content item in a given candidate playlist has a same combination of attribute values, assign a score to each candidate playlist in the set, and present, via a display, a subset of candidate playlists, each candidate playlist in the subset being selected from the set of candidate playlists based on the assigned score of the candidate playlist. In one example implementation that optionally may be combined with any of the features described herein, each content item in the collection of content items has a plurality of attributes, and each candidate playlist in the set is associated with a different combination of attribute values of the plurality of attributes such that each content item in a given candidate playlist has a same combination of attribute values. In one example implementation that optionally may be combined with any of the features described herein, the set of candidate playlists includes candidate playlists associated with every combination of attribute values for the attributes of the content items in the collection of content items. In one example implementation that optionally may be combined with any of the features described herein, the plurality of attributes include a genre, an era, a mood, and a geographical origin. In one example implementation that optionally may be combined with any of the features described herein, the storage device holds instructions executable by the logic device to, for each candidate playlist, select a plurality of content items from the collection of content items based on applying one or more content item selection rules. In one example implementation that optionally may be combined with any of the features described herein, one or more attributes of the plurality of attributes has a hierarchy of attribute values, and applying the one or more content item selection rules includes, if a candidate playlist is associated with an attribute value of an attribute that has a hierarchy of attribute values, then excluding content items having ancestor attribute values of the attribute value in the hierarchy from inclusion in the candidate playlist. In one example implementation that optionally may be combined with any of the features described herein, the storage device holds instructions executable by the logic device to exclude one or more of the plurality of candidate playlists from inclusion in the subset of candidate playlist based on applying one or more playlist exclusion rules. In one example implementation that optionally may be combined with any of the features described herein, the storage device holds instructions executable by the logic device to, for each attribute value, determining a precision value that represents a number of content items that have the attribute value relative to a total number of content items in the collection, for each candidate playlist, determining a precision score that represents an average of the precision values of a plurality of attribute values associated with the candidate playlist, and applying the one or more playlist exclusion rules includes, excluding each candidate playlist having a precision score greater than a precision threshold from inclusion in the subset of candidate playlists.

In another example implementation, on a computing device comprising a processor, a method for generating playlists of content items from a collection of content items, the method comprises determining, with the processor, a set of candidate playlists, each candidate playlist including a different plurality of content items selected from the collection of content items, each content item in the collection of content items having a plurality of attributes, each candidate playlist in the set being associated with a different combination of attribute values of the plurality of attributes such that each content item in a given candidate playlist has a same combination of attribute values, and the set including candidate playlists associated with every combination of attribute values for the attributes of the content items in the collection of content items, assigning, with the processor, a score to each candidate playlist in the set, and presenting, via a display, a subset of candidate playlists, each candidate playlist in the subset being selected from the set of candidate playlists based on the assigned score of the candidate playlist.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing device comprising a processor, a method for generating playlists of content items from a collection of content items, the method comprising:
determining, via the processor, a set of candidate playlists, each candidate playlist including a different plurality of content items selected from the collection of content items;
assigning, via the processor, a score to each candidate playlist in the set; and
presenting, via a display, a subset of candidate playlists, each candidate playlist in the subset being selected from the set of candidate playlists based on the assigned score of the candidate playlist.

2. The method of claim 1, wherein each content item in the collection of content items has a plurality of attributes, and wherein each candidate playlist in the set is associated with a different combination of attribute values of the plurality of attributes such that each content item in a given candidate playlist has a same combination of attribute values.

3. The method of claim 2, wherein the set of candidate playlists includes candidate playlists associated with every combination of attribute values for the attributes of the content items in the collection of content items.

4. The method of claim 2, wherein the plurality of attributes include a genre, an era, a mood, and a geographical origin.

5. The method of claim 2, further comprising:
for each candidate playlist, selecting, via the processor, a plurality of content items from the collection of content items based on applying one or more content item selection rules.

6. The method of claim 5, wherein one or more attributes of the plurality of attributes has a hierarchy of attribute values, and wherein applying the one or more content item selection rules includes, if a candidate playlist is associated with an attribute value of an attribute that has a hierarchy of attribute values, then excluding content items having ancestor attribute values of the attribute value in the hierarchy from inclusion in the candidate playlist.

7. The method of claim 5, wherein each candidate playlist includes a maximum threshold number of content items, and wherein applying the one or more content item selection rules includes,
if a number of content items that match the combination of attribute values associated with the candidate playlist is greater than the maximum threshold number of content items, then selecting content items that match the combination of attribute values and have a high recent local or global geographic usage and a low recent personal usage for inclusion in the candidate playlist over content items that match the combination of attribute values and have a high recent personal usage.

8. The method of claim 2, further comprising:
excluding, via the processor, one or more of the plurality of candidate playlists for inclusion in the subset of candidate playlist based on applying one or more playlist exclusion rules.

9. The method of claim 8, wherein one or more attributes of the plurality of attributes includes a hierarchy of attribute values, and wherein applying the one or more playlist exclusion rules includes,
if a first candidate playlist and a second candidate playlist have a single attribute with differing attribute values,
if the single attribute has a hierarchy of attribute values, and
if the differing attribute values have an ancestor/descendent relationship, then excluding the first candidate playlist having the ancestor attribute value from inclusion in the subset of candidate playlists.

10. The method of claim 8, further comprising:
for each attribute value, determining a precision value that represents a number of content items that have the attribute value relative to a total number of content items in the collection;
for each candidate playlist, determining a precision score that represents an average of the precision values of a plurality of attribute values associated with the candidate playlist; and
wherein applying the one or more playlist exclusion rules includes excluding each candidate playlist having a precision score greater than a precision threshold from inclusion in the subset of candidate playlists.

11. The method of claim 8, wherein applying the one or more playlist exclusion rules includes, upon two candidate playlists having greater than a threshold percentage of common content items, excluding a candidate playlist of the two candidate playlists having a lower assigned score from inclusion in the subset of candidate playlists.

12. A computing system comprising:
a logic device;
a storage device holding instructions executable by the logic device to:
determine a set of candidate playlists, each candidate playlist including a different plurality of content items selected from a collection of content items, each content item in the collection of content items having a plurality of attributes, and each candidate playlist in the set being associated with a different combination of attribute values of the plurality of attributes such that each content item in a given candidate playlist has a same combination of attribute values;
assign a score to each candidate playlist in the set; and
present, via a display, a subset of candidate playlists, each candidate playlist in the subset being selected from the set of candidate playlists based on the assigned score of the candidate playlist.

13. The computing device of claim 12, wherein each content item in the collection of content items has a plurality of attributes, and wherein each candidate playlist in the set is associated with a different combination of attribute values of the plurality of attributes such that each content item in a given candidate playlist has a same combination of attribute values.

14. The computing device of claim 13, wherein the set of candidate playlists includes candidate playlists associated with every combination of attribute values for the attributes of the content items in the collection of content items.

15. The computing device of claim 13, wherein the plurality of attributes include a genre, an era, a mood, and a geographical origin.

16. The computing device of claim 13, wherein the storage device holds instructions executable by the logic device to:
for each candidate playlist, select a plurality of content items from the collection of content items based on applying one or more content item selection rules.

17. The computing device of claim 16, wherein one or more attributes of the plurality of attributes has a hierarchy of attribute values, and wherein applying the one or more content item selection rules includes, if a candidate playlist is associated with an attribute value of an attribute that has a hierarchy of attribute values, then excluding content items having ancestor attribute values of the attribute value in the hierarchy from inclusion in the candidate playlist.

18. The computing device of claim 13, wherein the storage device holds instructions executable by the logic device to exclude one or more of the plurality of candidate playlists from inclusion in the subset of candidate playlist based on applying one or more playlist exclusion rules.

19. The computing device of claim 18, wherein the storage device holds instructions executable by the logic device to
for each attribute value, determining a precision value that represents a number of content items that have the attribute value relative to a total number of content items in the collection;
for each candidate playlist, determining a precision score that represents an average of the precision values of a plurality of attribute values associated with the candidate playlist; and
wherein applying the one or more playlist exclusion rules includes, excluding each candidate playlist having a precision score greater than a precision threshold from inclusion in the subset of candidate playlists.

20. On a computing device comprising a processor, a method for generating playlists of content items from a collection of content items, the method comprising:
determining, with the processor, a set of candidate playlists, each candidate playlist including a different plurality of content items selected from the collection of content items, each content item in the collection of content items having a plurality of attributes, each candidate playlist in the set being associated with a different combination of attribute values of the plurality of attributes such that each content item in a given candidate playlist has a same combination of attribute values, and the set including candidate playlists associated with every combination of attribute values for the attributes of the content items in the collection of content items;
assigning, with the processor, a score to each candidate playlist in the set; and
presenting, via a display, a subset of candidate playlists, each candidate playlist in the subset being selected from the set of candidate playlists based on the assigned score of the candidate playlist.
